(19) United States
(12) Patent Application Publication
(10) Pub. No.: US 2007/0156835 A1
(43) Pub. Date: Jul. 5, 2007

(54) Exchanging data between enterprise computing systems and service provider systems

(76) Inventors: Sebastian Pulkowski, St. Leon-Rot (DE); Stefan Krimmel, Muehlhausen (DE)

Correspondence Address: FISH & RICHARDSON, P.C., PO BOX 1022, MINNEAPOLIS, MN, 55440-1022, US

(21) Appl. No.: 11/323,667

(22) Filed: Dec. 30, 2005

(51) Int. Cl. G06F 15/16

(52) U.S. Cl. 709/207

(57) ABSTRACT

A computer-implemented method may include executing, in a first computing system, two or more service processes, each service process, when executed, retrieving a distinct type of data from the computing system; storing the retrieved data in a table; encapsulating the table in an extensible markup language (XML) message; and transmitting the XML message to a second computing system for processing. The second computing system may be operable to extract the encapsulated table from the XML message, extract two or more data components from the extracted table and route the two or more data components to system components associated with the second computing system. The system components may include a first processor and a second processor. The first processor may generate follow-up data in response to one of the two or more data components, and the follow-up data may be responsive to the retrieved data.

### TECHNICAL FIELD

This document relates to exchanging data between an enterprise computing system and a service provider system.

### BACKGROUND

Enterprise computing systems may facilitate efficient planning and delivery of a large organization's products and services to consumers. Such systems may incorporate an extensive array of computer hardware such as application servers, data servers, networking equipment and client computer devices. The client computer devices may access the data in application servers via a network such as an intranet or via secure channels over the internet. Data and application servers may be centrally organized in one or more data centers, or the servers may be distributed across departments and sites of the organization.

An enterprise computing system may employ various software packages to manage data within the organization. Many large organizations utilize enterprise software, such as enterprise resource planning (ERP) software to centrally manage data for various departments of the organization and to automate various organization activities. In general, ERP software allows a company to efficiently process data that is used by multiple departments. As an example, a manufacturing company may employ an ERP system to manage its manufacturing, sales and financial departments. More particularly, an ERP system may provide resources for a sales department to track orders for products; resources for a purchasing department to track orders for parts needed to manufacture the ordered products; resources for a manufacturing department to track products through the manufacturing process and to manage inventory; resources for a sales department to track order fulfillment and generally manage interactions with customers; and resources for a financial department to track parts costs, pay suppliers, track orders and process payments for fulfilled orders.

The software portion of an enterprise computing system may include various modules that may be used alone or integrated with other modules. For example, an organization may employ a supply chain management (SCM) module to support the organization's manufacturing operations; an organization may employ a customer relations management (CRM) module to log interactions between, for example, a marketing department and a prospective customer or a support department and a current customer; and an organization may employ a financials module to budget its operations, pay suppliers and employees, and receive payment from customers. Some organizations may employ an ERP system that integrates each of these modules into a single integrated system.

Enterprise systems are generally very complex and expensive to implement. Portions of an enterprise system may be customized to meet specific needs of an organization. To implement an enterprise system, an organization may employ various business and technical consultants to analyze the organization's workflows and processes; identify appropriate enterprise software components; install the components on the organization's existing computer hardware infrastructure or on new computer hardware; integrate various software components; and customize various user interfaces provided by the components, in order to meet specific needs of the organization. For many organizations, this implementation process may require many months of effort and may cost between tens of thousands of dollars and millions of dollars.

Once an enterprise system is implemented, its various components may be periodically updated to provide new features or to implement fixes to identified problems. Maintaining an enterprise system can require significant effort because of the sheer complexity, size and level of integration of the various components. To maintain an enterprise system, enterprise system administrators may regularly interact with enterprise system software providers or with third party consultants or service providers to learn of updates or fixes and to subsequently install and test the updates and fixes. Additionally, to maintain the enterprise system, system administrators may exchange various information with the enterprise system software providers or with third party consultants or service providers.

### SUMMARY

This document generally describes systems and techniques for exchanging data between a first computing system, such as an enterprise computing system, and a second computing system, such as a service provider system (e.g., an enterprise software provider or a third-party enterprise software consultant). The systems and techniques described herein may be used to automate the exchange of information needed for an organization's system administrator to maintain an enterprise computing system. More particularly, information may be collected from various sources within the enterprise computing system, aggregated, formatted into a standard format, and transmitted to a third party. In response to the transmitted information, follow-up information may be received from the third party. The follow-up information may include, for example, software updates to various components of the enterprise computing system, new features for implementation in the enterprise computing system, or reports providing analysis of the transmitted information. Moreover, the systems and techniques may be used by a software provider to manage licenses or to gather data for internal planning (e.g., planning future improvements to the enterprise software), or by a third-party service provider to provide service for an enterprise system (e.g., preventative system checks or monitoring and optional application of software patches in response to preventative system checks or monitoring). The standard format of the transmitted information may allow various third-parties to provide other custom services or follow-up information in response to the transmitted information.

In one general aspect, a computer-implemented method includes executing, in a first computing system, two or more service processes, each service process, when executed, retrieving a distinct type of data from the computing system; storing the retrieved data in a table; encapsulating the table in an extensible markup language (XML) message; and transmitting the XML message to a second computing system for processing. The second computing system may be operable to extract the encapsulated table from the XML message, extract two or more data components from the extracted table and route the two or more data components to system components associated with the second computing system.

In some implementations, the system components include a first processor and a second processor. The first processor may generate follow-up data in response to one of the two or more data components, and the follow-up data may be responsive to the retrieved data. The computer-implemented method may further include transmitting a polling message to the second computing system, and receiving in response to the polling message, the follow-up data. In some implementations, at least one service process of the two or more service processes may be scheduled to be executed periodically at an initial frequency. The follow-up data may cause the initial frequency to be adjusted.

In some implementations, the follow-up data may comprise a list of one or more available software updates. The computer-implemented method may further include retrieving at least one available software update in the list of the one or more available software updates and installing the software update without corresponding human interaction.

In some implementations, the distinct type of data may be a hardware specification of the first computing system; the distinct type of data may be software profile information corresponding to software that is installed in the first computing system (e.g., profile information that enumerates installed components, licensed software modules, or data objects related to installed components or licensed software modules; or configuration parameters associated with installed components or licensed software modules). The distinct type of data may be an incident description comprising information about an exception that resulted from the first computing system executing installed software; the incident description may further include information entered by a user of the first computing system in response to the exception. The distinct type of data may be database information corresponding to a database that is maintained by installed software; the database information may include at least one of a number of users who access the database, a capacity of the database, or a memory usage profile corresponding to the database.

In some implementations, the first computing system may include a server and a plurality of client devices coupled to the server; the server may execute enterprise software that is accessible from one or more of the plurality of client computer devices. The enterprise software may provide tools and applications to manage data associated with at least one function of an organization. The function may be one of manufacturing, logistics, distribution, inventory, shipping, invoicing or accounting.

In some implementations, a service process of the plurality of service processes may be executed in response to input from a user of the computing system. The table includes a first part and a second part. The first part includes the retrieved data and the second part includes an index that indexes the retrieved data in the first part.

In another general aspect, a computer-implemented method may include receiving, from a remote computing system, an XML message that encapsulates a table having at least a first data component and a second data component; the first data component may have a first data type, and the second data component may have a second data type that is different than the first data type. The computer-implemented method may further include extracting the table from the XML message, extracting the first data component and the second data component from the extracted table and routing the first data component to a first processor that generates follow-up data in response to the first data component. The computer-implemented method may further include receiving from the remote computing system a polling message, and transmitting to the remote computing system, in response to the polling message, the follow-up data.

Advantages of the systems and techniques described herein may include any or all of the following. Information about an enterprise computing system, for use by a service provider to maintain an organization's enterprise computing system, may be gathered and transmitted to the service provider's system in an automated fashion. Follow-up information may be received from the service provider, and the follow-up information may cause software to be automatically installed or new features to be automatically implemented. Such automation may allow an organization to maintain a smaller information technology (IT) department than may be otherwise possible.

The general and specific aspects may be implemented using a system, a method, or a computer program, or any combination of systems, methods, and computer programs. The details of one or more implementations are set forth in the accompanying drawings and the description below.

### DESCRIPTION OF DRAWINGS

These and other aspects will now be described in detail with reference to the following figures.

FIG. 1 is a flow diagram illustrating a method of collecting, aggregating and transmitting data from a first computing system to a second computing system, according to some implementations.

FIG. 2 is a block diagram of a first computing system, in which the method that was described with reference to FIG. 1 may be implemented, and a second computing system that is coupled to the first computing system, according to some implementations.

FIG. 3 is a block diagram showing additional details of the communication channel that is shown in FIG. 2, according to some implementations.

FIG. 4A and FIG. 4B are flow diagrams that further illustrate the exchange of information between a first computing system and a second computing system 402, according to some implementations.

FIG. 5 is a block diagram of a computer device, according to some implementations.

Like reference symbols in the various drawings indicate like elements.

### DETAILED DESCRIPTION

This document generally describes systems and techniques for exchanging data between a first computing system, such as an enterprise computing system, and a second computing system, such as a service provider system (e.g., an enterprise software provider or a third-party enterprise software consultant). The systems and techniques described herein may be used to automate the exchange of information needed for an organization's system administrator to maintain an enterprise computing system. More particularly, information may be collected from various sources within the enterprise computing system, aggregated, formatted into a standard format, and transmitted to a third party. In response to the transmitted information, follow-up information may be received from the third party. The follow-up information may include, for example, software updates to various components of the enterprise computing system, new features for implementation in the enterprise computing system, or reports providing analysis of the transmitted information. Moreover, the systems and techniques may be used by a software provider to manage licenses or to gather data for internal planning (e.g., planning future improvements to the enterprise software), or by a third-party service provider to provide service for an enterprise system (e.g., preventative system checks or monitoring and optional application of software patches in response to preventative system checks or monitoring). The standard format of the transmitted information may allow various third-parties to provide other custom services or follow-up information in response to the transmitted information.

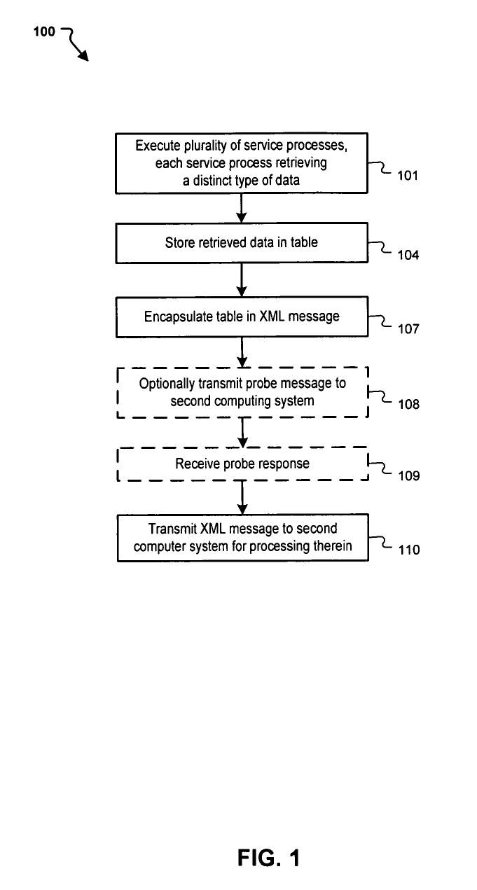

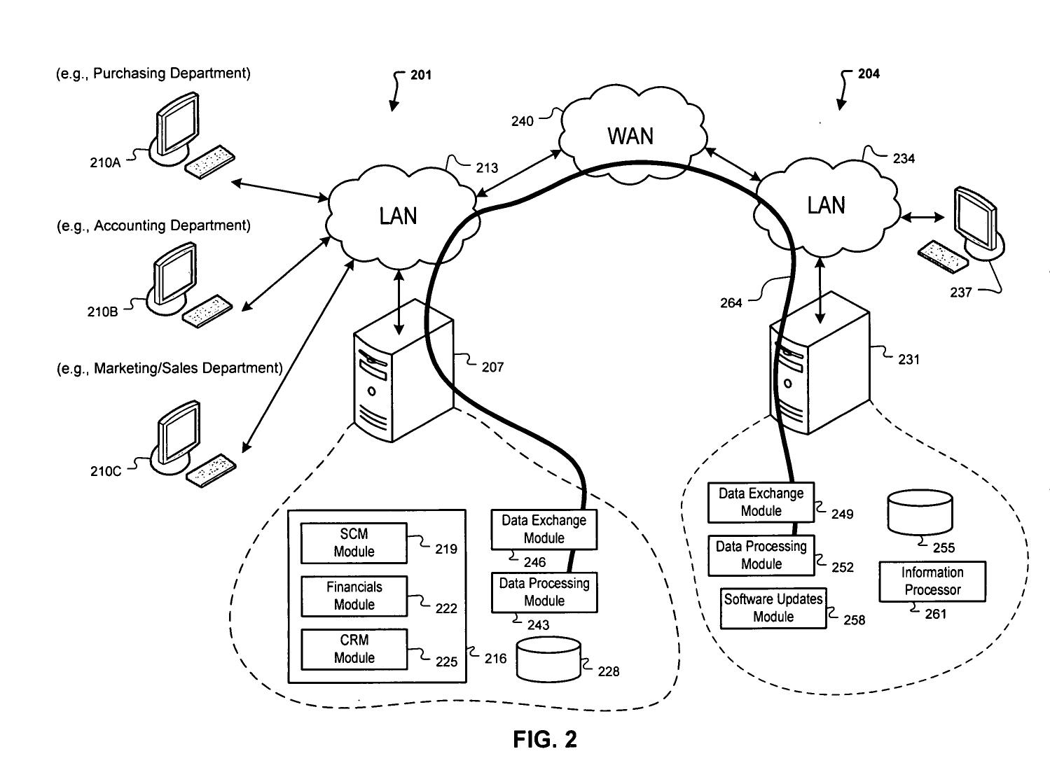

FIG. 1 is a flow diagram illustrating a method 100 of collecting, aggregating and transmitting data from a first computing system to a second computing system. In some implementations, the method 100 may be implemented by computer hardware and software within an enterprise computing system, such as the computing system that is shown in FIG. 2.

The method 100 executes, at 101, a plurality of service processes that each retrieves a distinct type of data. The service processes may be, for example, software routines that are scheduled to run periodically (e.g., hourly, daily, weekly, quarterly, etc.), or they may be configured to run in response to user input. A service process may be called directly by an enterprise computing system software component, or the service process may be dynamically called by a services broker from services catalogued in a services registry (e.g., in a service-oriented software architecture). Each service process may retrieve a distinct type of data that provides information about the enterprise computing system.

Examples of distinct data types are now provided. The data may include general network specifications, such as, for example, a number of server devices, a number of client devices or a network speed and topology description. The data may include hardware specifications for server or client computer devices, such as, for example, processor type and speed, memory type and capacity, storage and operating system type and version information. The data may include information about a number of users with accounts on the enterprise computing system and a description and breakdown of the types of user accounts. The data may include profile information corresponding to software packages or modules that are installed on the enterprise computing system. The profile information may enumerate installed software components, licensed software modules, or data objects associated with installed components or licensed software modules. The profile information may also include configuration parameters associated with installed components or licensed software modules, and the profile information may further identify a provider of one or more software components or licensed software modules. The data may include information about databases maintained by various software packages or modules, such as, for example, a database type, a description of database structure, amount of memory or storage space allocated to the database, remaining capacity of the database, a number and a description of types of users associated with the database and memory (e.g., RAM or cache) usage profiles of the database. The data may include information about one or more exceptions that resulted from execution of a software package or module on the enterprise computing system, such as, for example, information about the exception itself, the software package or module that caused the exception, user-entered comments about the exception and memory logs associated with the exception.

Retrieved data is stored, at 101, in a table. At least two types of distinct data are stored in the table. In some implementations, the table includes two parts—a first part that includes the actual data having two or more distinct types, and a second part that includes an index that indexes the data in the first part. The index may serve as a “table of contents” to the first part. Data in both the first part and the second part of the table may have a human-readable format, or the data may be encoded in a format that is not human-readable.

After the data is stored in the table, at 107, it is encapsulated in an extensible markup language (XML) message. An XML format for the message may enable the message to be conveyed over various networks using standard existing network protocols. In some implementations, the XML message may require translation from a proprietary format to another, more readily accessible format. In some implementations, the XML message may be processed without any translation. (In this context, “translation” refers to conversion from one format to another, rather than mere manipulation of fields or sections of data to, for example, extract portions of data, intact, from larger blocks of data).

The XML message is transmitted, at 110, to a second computing system for processing. In some implementations, the second computing system is a computing system maintained by an enterprise software provider; in some implementations, the second computing system is maintained by a third-party consultant or service provider. The second computing system may receive the XML message, extract the table from it, extract data from the table, analyze the data and provide follow-up data in response.

Optionally, a probe message may be transmitted, at 108, to the second computing system. The probe message may be a short a message, such as a “ping” message, that elicits a response from the second computing system. If a functional connection exists between the first computing system and the second computing system, a response to the probe message may be received, at 109. In some implementations, the XML message may only be transmitted if a functional connection has been verified between the first computing system and the second computing system. In some implementations, if a functional connection has not been verified, the first computing system may wait a predetermined period of time, transmit, at 108, another probe response, and wait to receive, at 109, a probe response; this process may be repeated until a functional connection between the first computing system and the second computing system has been verified, at which point the XML message may be transmitted at 110. In some implementations, if a functional connection has not been verified, the method may automatically open a functional connection (e.g., by sending a control message or a service request, or by taking other action necessary to open a connection).

FIG. 2 is a block diagram of first computing system 201, such as an enterprise computing system associated with an organization, in which the method 100 that was described with reference to FIG. 1 may be implemented. Also shown is a second computing system 204 that is coupled to the first computing system and that may process data transmitted by the first computing system 201. As shown in FIG. 2, the first computing system 201 includes at least one server device 207, a plurality of client devices 210A, 210B and 210C, and a network 213, such as a local area network (LAN) that couples the sever device 207 and the client devices 210A, 210B and 210C.

In some implementations, the server device 207 runs an organization's enterprise computing software that may be accessed from the various client devices 210A, 210B and 210C. For example, the server device 207 may run ERP software 216 that includes an SCM module 219 that may be accessible from a Purchasing Department computer device (e.g., computer device 210A), a financials module 222 accessible from an Accounting Department computer device (e.g., computer device 210B), and a CRM module 225 accessible from a Marketing/Sales Department computer device (e.g., computer device 210C). The ERP software 216 may cause the server device 207 to maintain a database 228 for storing data associated with the various modules 219, 222 and 225 of the ERP software 216. For example, the ERP software 216 may cause the server device 207 to store sales orders entered by a user of the computer device 210C, or financial data entered by a user of the computer device 210B, or purchase orders for parts entered by a user of the computer device 210A. The data in the database 228 may be accessible by multiple software modules, and data may be interrelated. For example, upon receipt of a sales order from the CRM module 225, the ERP software 216 may store an entry in an “accounts receivable” data field associated with the financials module 222.

Also shown in FIG. 2 is a second computing system 204 which also includes at least one server device 231, a LAN 234, and at least one client computer device 237. As shown, the second computing system 204 and the first computing system 201 are coupled by a network 240, such as a wide area network (WAN) (e.g., the Internet). Through the networks 213, 240 and 234, various devices 207, 210A, 210B and 210C in the first computing system 201 may communicate with one or more devices in the second computing system 204.

In some implementations, the second computing system 204 is a software provider, such as the provider of the ERP software 216, or of one or more of the ERP modules 219, 222 or 225. In some implementations, a third-party service provider, such as a consulting service provider, maintains the second computing system 204. In any case, the second computing system 204 may be configured to receive information from the first computing system 201, and to provide one or more support services in response to the received information. The first computing system 201 may be configured to automatically collect various information about the first computing system 201, aggregate the collected information and transmit it to the second computing system 204. A process by which information may be exchanged between the first computing system 201 and the second computing system 204 is now described in more detail.

In some implementations, the first computing system 201 includes a data processing module 243 that collects various information about the first computing system 201. The information may have various data types, examples of which are described above with reference to FIG. 1. Multiple units of information may be stored in the database after being retrieved or collected by the data processing module 243. At some point, this stored information may be aggregated, packaged and transmitted by a data exchange module 246. In some implementations, the data exchange module 216 may package the aggregated data in a format that can be transmitted over the networks 213, 240 and 234, such as, for example, an XML message format.

As shown, the computing system 204 includes a corresponding data processing module 249 to receive data transmitted by the first computing system 201 (e.g., XML messages transmitted by the data exchange module 246). The second computing system 204 may also include a corresponding data processing module 252 that may “unpack” data received from the first computing system. (The foregoing modules 243, 246, 249 and 252, and the intervening server devices 207 and 231 and networks 213, 240 and 234 may, together, form a “data channel” 264.) In some implementations, unpacking may involve extracting data from an XML message, further extracting smaller units of data from a block of data extracted from the XML message, and routing the smaller units of data to different locations within the second computing system 204. In some implementations, information having different data types may be routed to different locations based on its data type. For example, referring to the description of data types above, data related to general network specifications may be routed to a database, such as a database 255, which may store information corresponding to various system profiles; data related to software packages or modules installed on an enterprise computing system (e.g., the system 201) may be routed to a software update module 258. Other types of information may be routed to other locations (not shown).

An information processor 261 may analyze information stored in various locations in the second computing system (e.g., the system profile database 255 or the software update module 258) to provide useful follow-up information for the first computing system 201. For example, the information processor 261 may identify available software updates for the first computing system 201, based on general network specifications of the system 201 and data related to software packages or modules installed on the system 201. The second computing system 204 may send this follow-up information (e.g., available software updates) to the first computing system 201 via the same data exchange channel 264 that is described above. More particularly, the second computing system 204 may employ the data exchange module 249 to create a message (e.g., an XML message) that includes or references the software update information and send the message to the data exchange module 246 in the first computing system 201, via the networks 234, 240 and 213.

In some implementations, the data exchange module 246 and the data processing module 243 may automatically process follow-up information that is received from the second computing system 204. For example, if the follow-up information includes a list of available software updates, the modules 246 and 243 may automatically retrieve and install the updates, depending on how the first computing system 201 is configured. In this manner, the first computing system 201 (e.g., an enterprise computing system) may be maintained with little or no user interaction.

In addition to software update information, other kinds of information may be exchanged between the first computing system 201 and the second computing system 204 via the communication channel 264. For example, the various components in the communication channel 264 may be configured to provide runtime analysis of software running in the first computing system 201 to identify and fix bugs, or to provide additional software services or enhancements to the ERP software 216.

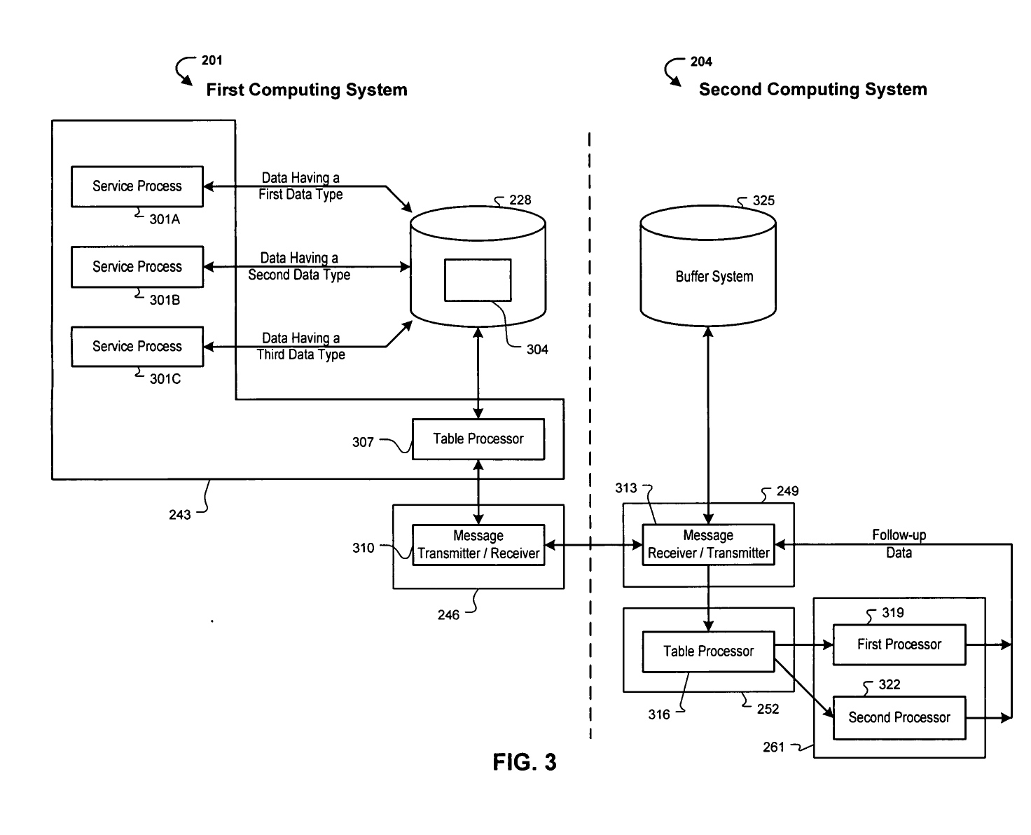

FIG. 3 is a block diagram showing additional details of the communication channel 264 that is described with reference to FIG. 2. As shown, the data processing module 243 may include various service processes 301A, 301B and 301C, each of which collects data having a different data type. For example, the service process 301A may collect general network specifications related to the first computing system 201. Network specifications may include, for example, a number of server devices and client computer devices in the first computing system 201. The service process 301A may also retrieve various parameters related to the network 213, such as network topology and speed. To collect this information, the service process 301A may cause the server device 207 to search for and analyze various configuration or system files (e.g., registry files) stored in the first computing system 201. In some implementations, initial configuration of the data processing module 243 may include specification of the location of such configuration or system files. As another example, the service process 301B may collect data related to software packages or modules that are installed in the first computing system 201. To collect this information, the service process 301B may also cause the server device 207 to search for and analyze various configuration or system files (e.g., registry files) stored in the first computing system 201. Again, initial configuration of the data processing module 243 may include specification of the location of such files.

Data that is retrieved or collected by the service processes 301A, 301B and 301C may be stored in a table 304. In some implementations, the table has at least a first part for the retrieved or collected data, and a second part that may index the first part. The first computing system 201 may use a table processor 307 to process the data. Processing the data may include, for example, encoding it in a particular format, or generating an index for the data and storing the index in the second part of the table. The table processor 307 may also encapsulate the table in a message (e.g., an XML message) for further routing and processing. Processing the data may also include, for example, pre-processing data within the computing system 201 to minimize the amount of data that is encapsulated in the message and subsequently transmitted for processing outside of the computing system 201. For example, in some implementations, a large amount of data may be retrieved or collected by the service processes 301A, 301B and 301 C, but only a portion of this data may be ultimately encapsulated in a message. Further, processing may include translation of data from one format to another (e.g., from a proprietary format to a readily-accessible format).

As shown, a message transmitter/receiver 310 is included in the data exchange module 246. The message transmitter/receiver 310 may transmit messages (e.g., XML messages that include encapsulated tables that store various data) to the second computing system 204.

A data exchange module 249 in the second computing system 204 may include a corresponding message receiver/transmitter 313 to exchange messages with the first computing system 201. A data processing module 252 in the second computing system 204 may include a corresponding table processor 316 that extracts tables from messages, and further extracts data from the tables. In some implementations, where the tables have a first part that includes data and a second part that includes an index to the data, the table processor 316 may analyze the index before extracting data from the table. Once it extracts data from tables in received messages, the table processor 316 may route the data to various processors 319 and 322 in the information processor 261. In some implementations, each processor 319 or 322 may process data having a particular data type. In some implementations, each processor may generate follow-up data to send back to the first computing system 201 (e.g., a list of pertinent, available software updates) or to store in the second computing system 204 (e.g., system profile information corresponding to the first computing system 201 that may be used, for example, to identify bugs or possible software enhancements). Follow-up data that is to be sent back to the first computing system 201 may be routed to the message receiver/transmitter 313 for this purpose.

In some implementations, the second computing system 204 may include a buffer system 325. The buffer system 325 may provide intermediate storage for messages that are to be exchanged by the first (201) and second (204) computing systems. Such a buffer system 325 may permit messages to be exchanged even if the first computing system 201 is “off-line.” As shown, the buffer system 325 is part of the second computing system 204, but it may also be a completely separate system that is interposed between the first computing system 201 and the second computing system 204; in such a scenario, the buffer system 325 may facilitate asynchronous message exchange if either computing system 201 or 204 were off-line.

The buffer system 325 may also provide load balancing for the exchange of messages. For example, although only a single “first computing system” 201 is illustrated in the figures, the reader should appreciate that many similar systems may connect to the second computing system 204 in the representative manner illustrated by the first computing system 201. For example, many organizations' enterprise computing systems may connect to an enterprise software provider's system or to a third party's service system (e.g., 204). Because each such system may asynchronously transmit messages to the second computing system 204, the buffer system 325 may balance peaks in message volume by temporarily storing the messages.

In some implementations, the first computing system 201 and the buffer system 325 may interact with a handshaking protocol. For example, before transmitting data, the first computing system 201 may transmit a “probe message” to the second computing system 204 or to the buffer system 325. The probe message may be designed to elicit an immediate, or almost immediate, “probe response.” Thus, if the first computing system 201 receives a probe response after sending a probe request, it may subsequently transmit a data message. On the other hand, if the first computing system 201 does not receive a probe response after sending a probe request, the system 201 may queue a corresponding data message and transmit it later. For example, the system 201 may send the data message after a predetermined delay period and after receiving a probe response in response to a probe request. In some implementations, a handshaking protocol may be used in either direction. For example, the second computing system 304 may send a probe request to the first computing system 201 and wait for a probe response before subsequently “pushing” a message to the first computing system 201.

In some implementations, the second computing system 204 may only transmit messages to the first computing system 201 upon receipt of a probe message from the first computing system 201. Before that time, the second computing system 204 may queue any messages to the first computing system in the buffer system 325. Such implementations may minimize data traffic between the first computing system 201 and the second computing system 204 by allowing the first computing system 201 to control when a data channel between the systems 201 and 204 exists. In some implementations, transmission of a probe request from the first computing system 201 may “open” the data channel for a predetermined period of time (e.g., 30 seconds, 5 minutes, 2 hours, 1 week, 1 month, etc.), during which time, the second computing system 204 may send to the first computing system 201 any queued messages, such as messages that include follow-up information (e.g., available software update information). In some implementations, the second computing system 204 may only send messages to the first computing system 201 directly in response to a probe request (e.g., synchronously).

In some implementations, the buffer system 325 may include a buffer database (not shown) for storing queued messages. In some implementations, the buffer system 325 may include an index of content stored within; the index may include information about a message's source and destination, information about a process that created the message, a timestamp associated with the message and other descriptive information.

In some implementations, the first computing system 201 may be configured to periodically perform certain functions, such as, for example, executing the various service processes 301A, 301B and 301C; encapsulating a table into a message and transmitting the message to the second computing system 204; or sending a probe message in order to open a data channel and receiving follow-up messages from the second computing system 204. In some implementations, a frequency at which such periodic functions are performed may be configurable. For example, a user of the first computing system 201 may configure this frequency, or the second computing system 204 may adjust the frequency by sending a message to the first computing system 201.

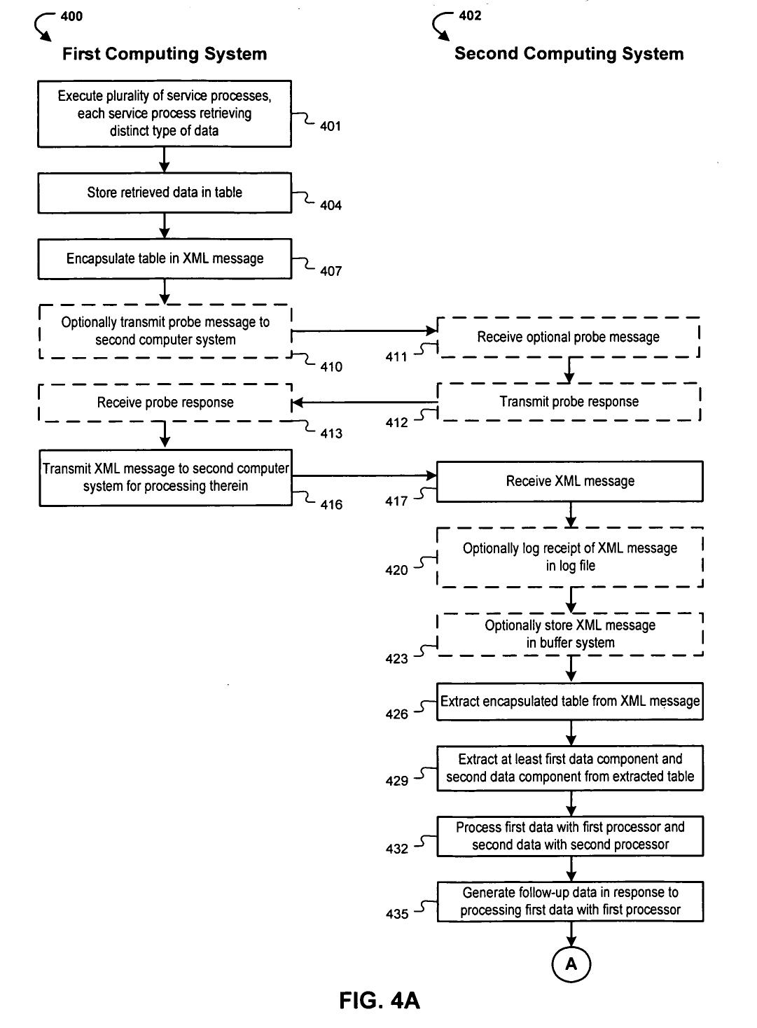

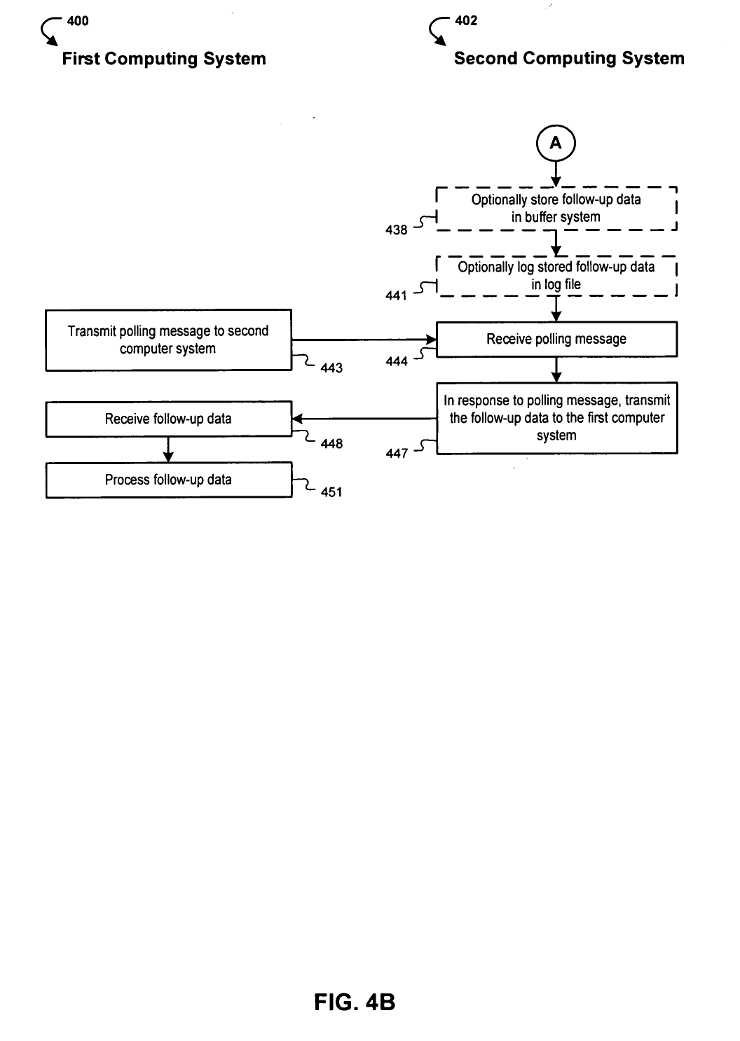

FIG. 4A and FIG. 4B are flow diagrams that further illustrate the exchange of information between a first computing system 400 and a second computing system 402, according to some implementations. The first computing system 400 may be remote relative to the second computing system 402. The first computing system 400 executes, at 401, a plurality of service processes that each retrieves a distinct type of data. For example, referring to FIG. 3, the first computing system 201 may execute service processes 301A, 301B and 301C to retrieve data having a first data type, a second data type and a third data type, respectively. The first computing system 400 stores, at 404, the retrieved data in a table. For example, referring to FIG. 3, the first computing system 201 may store the retrieved data in a table 304. The first computing system 400 encapsulates, at 407, the table in an XML message. For example, referring to FIG. 3, the first computing system 201 may use the table processor 307 to encapsulate the table 304 in an XML message.

In some implementations, the first computing system 400 may transmit, at 410, a probe message to the second computing system 402. If a channel is open between the first computing system 400 and the second computing system 402, the second computing system receives, at 411, the probe message. In response, the second computing system 402 transmits, at 412, a probe response to the first computing system 400, which receives, at 413, the probe response. For example, referring to FIG. 3, the first computing system 201, employing a message transmitter/receiver 310, may transmit a probe response to the second computing system 204—specifically to the message receiver/transmitter 313. If a channel is open, the message receiver/transmitter 313 may send a probe response back to the message transmitter/receiver 313, which may receive the probe response.

The first computing system 400 transmits, at 416, the XML message to the second computing system 402, which receives, at 417, the message. For example, referring to FIG. 3, the message transmitter/receiver 310 transmits an XML message that encapsulates the table 304 to the message receiver/transmitter 313, which receives the message.

In some implementations, the second computing system 402 logs, at 420, receipt of the XML message in a log file, and stores, at 423, the message in a buffer system. For example, referring to FIG. 3, the buffer system 325 may log receipt of the message in an index or log file (not shown) and store the message itself in a database (not shown) within the buffer system 325.

The second computing system 402 extracts, at 426, the encapsulated table from the XML message, then extracts, at 429, at least a first data component and a second data component from the extracted table. The second computing system 402 then routes the first and second data components to first and second processors, respectively. For example, referring to FIG. 3, the data processing module 252 first uses the table processor 316 to extract the encapsulated table 304 from the XML message, then uses the table processor 316 to extract data components from extract table, and routes a first extracted data component to the first processor 319 and a second extracted data component to a second processor 322.

The second computing system 402 processes, at 432, the first data component with a first processor and processes the second data component with a second processor. For example, referring to FIG. 3, the first processor 319 processes the first extracted data component, and the second processor 322 processes the second extracted data component.

The second computing system 402 generates, at 435, follow-up data in response to processing the first data with the first processor. For example, referring to FIG. 3, the first processor 319 generates follow-up data in response to processing the first extracted data component. More particularly, the first processor 319 may identify a list of available software updates for the first computing system 201.

In some implementations, the second computing system 402 may store, at 438, the follow-up data in a buffer system and may also log, at 441, the stored follow-up data in a log file in the buffer system. For example, referring to FIG. 3, the second computing system 204 may store the follow-up data in a database (not shown) in the buffer system 325, and may further log the follow-up data in a log file (not shown) in the buffer system 325.

The first computing system 400 may transmit, at 443, a “polling message” to the second computing system 402, and the second computing system 402 may receive, at 444, the polling message. For example, referring to FIG. 3, the first computing system 201, via the message transmitter/receiver 310, may send a polling message to the message receiver/transmitter 313; the message receiver/transmitter 313 may receive the message. In some implementations, the polling message may serve to both open a channel between the first computing system 201 and the second computing system 204 and to request, from the second computing system 204, any messages that may be queued for delivery to the first computing system 201.

The second computing system 402 may transmit, at 447, the follow-up data to the first computing system 400, and the first computing system 400 may receive, at 448, the follow-up data. For example, referring to FIG. 3, the second computing system 204, via the message receiver/transmitter 313, may transmit the follow-up data to the message transmitter/receiver 310. In some implementations, the follow-up data may be directly sent from the first processor 319; in some implementations, the follow-up data may be retrieved from the buffer system 325, where it is queued for delivery, and then sent to the message transmitter/receiver 310. In either case, the message transmitter/receiver 310 may receive the data.

The first computing system 400 may process, at 457, the follow-up data. For example, referring to FIG. 3, the data processing module 243 may process a list of available software updates and may subsequently retrieve the software updates and install them in the first computing system 201.

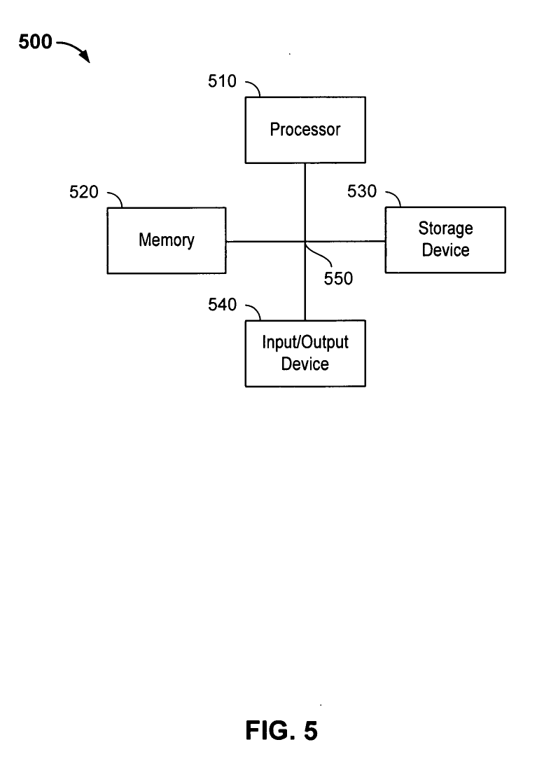

FIG. 5 is a block diagram of a computer device 500 that may be used in the operations described above, according to some implementations. The computer device 500 includes a processor 510, a memory 520, a storage device 530 and an input/output device 540. Each of the components 510, 520, 530 and 540 are interconnected using a system bus 550.

The processor 510 is capable of processing instructions for execution within the computer device 500. In some implementations, the processor 510 is a single-threaded processor. In other implementations, the processor 510 is a multi-threaded processor. The processor 510 is capable of processing instructions stored in the memory 520 or on the storage device 530 to display graphical information for a user interface on the input/output device 540.

The memory 520 stores information within the computer device 500. In some implementations, the memory 520 is a computer-readable medium. In some implementations, the memory 520 is a volatile memory unit. In some implementations, the memory 520 is a non-volatile memory unit.

The storage device 530 is capable of providing mass storage for the computer device 500. In some implementations, the storage device 530 is a computer-readable medium. In various other implementations, the storage device 530 may be a floppy disk device, a hard disk device, an optical disk device, or a tape device.

The input/output device 540 provides input/output operations for the computer device 500. In some implementations, the input/output device 540 includes a keyboard and/or pointing device. In some implementations, the input/output device 540 includes a display unit for displaying graphical user interfaces.

The method may be implemented in digital electronic circuitry, or in computer hardware, firmware, software, or in combinations of them. Apparatus may be implemented in a computer program product tangibly embodied in an information carrier, e.g., in a machine-readable storage device or in a propagated signal, for execution by a programmable processor; and actions of the method may be performed by a programmable processor executing a program of instructions to perform functions of the invention by operating on input data and generating output. Implementations may be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that may be used, directly or indirectly, in a computer to perform a certain activity or bring about a certain result. A computer program may be written in any form of programming language, including compiled or interpreted languages, and it may be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer may include a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, a computer device may include a display device such as a CRT (cathode ray tube) or LCD (liquid crystal display) monitor for displaying information to the user and a keyboard and a pointing device such as a mouse or a trackball by which the user may provide input to the computer.

Apparatus and methods disclosed herein may be implemented in a computing system that includes a back-end component, such as a data server; or that includes a middleware component, such as an application server or an Internet server; or that includes a front-end component, such as a client computer having a graphical user interface or an Internet browser, or any combination of them. The components of the system may be connected by any form or medium of digital data communication such as a communication network. Examples of communication networks include, e.g., a LAN, a WAN, and the computers and networks forming the Internet.

The computing system may include clients and servers. A client and server are generally remote from each other and typically interact through a network, such as the described one. The relationship of client and server may arise by virtue of computer programs running on the respective computers and having a client-server relationship to each other.

Implementations may include, at least in part, in hardware or software or in any combination thereof. Hardware may include, for example, analog, digital or mixed-signal circuitry, including discrete components, integrated circuits (ICs), or application-specific ICs (ASICs). Implementations may also be implemented, in whole or in part, in software or firmware, which may cooperate with hardware. Processors for executing instructions may retrieve instructions from a data storage medium, such as EPROM, EEPROM, NVRAM, ROM, RAM, a CD-ROM, a HDD, and the like. Computer program products may include storage media that contain program instructions for implementing implementations described herein.

A number of implementations have been described. Nevertheless, it should be understood that various modifications may be made without departing from the scope of this disclosure. Accordingly, other implementations are within the scope of the following claims.

What is claimed is:

1. A computer-implemented method comprising:
executing in a first computing system two or more service processes, each service process, when executed, retrieving a distinct type of data from the computing system;
storing the retrieved data in a table;
encapsulating the table in an extensible markup language (XML) message; and
transmitting the XML message to a second computing system for processing, wherein the second computing system is operable to extract the encapsulated table from the XML message, extract two or more data components from the extracted table and route the two or more data components to system components associated with the second computing system.

2. The computer-implemented method of claim 1, wherein the system components comprise a first processor and a second processor, and wherein the first processor generates follow-up data in response to one of the two or more data components, the follow-up data being responsive to the retrieved data.

3. The computer-implemented method of claim 2, further comprising:
transmitting a polling message to the second computing system; and
receiving in response to the polling message, the follow-up data.

4. The computer-implemented method of claim 3, wherein at least one service process of the two or more service processes is scheduled to be executed periodically at an initial frequency.

5. The computer-implemented method of claim 4, wherein the follow-up data causes the initial frequency to be adjusted.

6. The computer-implemented method of claim 3, wherein the follow-up data comprises a list of one or more available software updates.

7. The computer-implemented method of claim 6, further comprising retrieving at least one available software update in the list of the one or more available software updates and installing the software update without corresponding human interaction.

8. The computer-implemented method of claim 1, wherein the distinct type of data is a hardware specification of the first computing system.

9. The computer-implemented method of claim 1, wherein the distinct type of data is software profile information corresponding to software that is installed in the first computing system.

10. The computer-implemented method of claim 9, wherein the distinct type of data is an incident description comprising information about an exception that resulted from the first computing system executing installed software.

11. The computer-implemented method of claim 10, wherein the incident description further comprises information entered by a user of the first computing system in response to the exception.

12. The computer-implemented method of claim 1, wherein the distinct type of data is database information corresponding to a database that is maintained by installed software.

13. The computer-implemented method of claim 12, wherein the database information comprises at least one of a number of users who access the database, a capacity of the database, or a memory usage profile corresponding to the database.

14. The computer-implemented method of claim 1, wherein the first computing system comprises at least one server and a plurality of client devices coupled to the at least one server, and wherein the at least one server executes enterprise software that is accessible from one or more of the plurality of client computer devices.

15. The computer-implemented method of claim 14, wherein the enterprise software provides tools and applications to manage data associated with at least one function of an organization, the at least one function selected from the group consisting of manufacturing, logistics, distribution, inventory, shipping, invoicing and accounting.

16. The computer-implemented method of claim 1, wherein at least one service process of the plurality of services processes is executed in response to input from a user of the computing system.

17. The computer-implemented method of claim 1, wherein the table comprises a first part and a second part, the first part comprising the retrieved data and the second part comprising an index that indexes the retrieved data in the first part.

18. A computer-implemented method comprising:
receiving from a remote computing system an XML message that encapsulates a table having at least a first data component and a second data component, the first data component having a first data type, and the second data component having a second data type, the first data type and the second data type being different;
extracting the table from the XML message;
extracting the first data component and the second data component from the extracted table; and
routing the first data component to a first processor that generates follow-up data in response to the first data component.

19. The computer-implemented method of claim 18, further comprising:
receiving from the remote computing system a polling message; and
transmitting to the remote computing system, in response to the polling message, the follow-up data.

20. A computer program product, tangibly embodied in an information carrier, the computer program product comprising instructions that, when executed, cause a processor to perform operations comprising:
executing in a first computing system two or more service processes, each service process, when executed, retrieving a distinct type of data from the computing system;
storing the retrieved data in a table;
encapsulating the table in an extensible markup language (XML) message; and
transmitting the XML message to a second computing system for processing, wherein the second computing system is operable to extract the encapsulated table from the XML message, extract two or more data components from the extracted table and route the two or more data components to system components associated with the second computing system.
